(19) United States
(12) Patent Application Publication
(10) Pub. No.: US 2005/0243556 A1
(43) Pub. Date: Nov. 3, 2005

(54) Lighting system and method

(76) Inventor: Manuel Lynch, Tustin, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/929,287

(22) Filed: Aug. 30, 2004

Related U.S. Application Data
(60) Provisional application No. 60/567,225, filed on Apr. 30, 2004.
(60) Provisional application No. 60/569,984, filed on May 10, 2004.

(51) Int. Cl. H04M 1/22

(52) U.S. Cl. 362/276

(57) ABSTRACT

A lighting system and method is disclosed wherein a sensor module controls a lighting apparatus comprising lamps that emit light having a wavelength within a first range of wavelengths. The sensor module comprises a sensor that is configured to detect light having a wavelength within a second range of wavelengths. The first and second ranges do not overlap one another. Accordingly, the sensor is blind to light from the lighting device. The sensor module controls the illumination of the lighting device in accordance with a predetermined strategy based upon the detection of a threshold intensity of light by the sensor.

### PRIORITY INFORMATION

This application claims the benefit of U.S. Provisional Patent Application No. 60/567,225, filed on Apr. 30, 2004, and U.S. Provisional Patent Application No. 60/569,984, filed on May 10, 2004, each of which is hereby incorporated by reference in its entirety.

### BACKGROUND OF THE INVENTIONS

1. Field of the Inventions

The present invention relates to lighting devices and control of lighting devices.

2. Description of the Related Art

Light emitting diodes (LEDs) are currently used for many lighting applications. The compactness, efficiency and long life of LEDs is particularly desirable and makes LEDs well suited for many uses. For example, a plurality of LEDs can be used to appropriately light a lighting apparatus such as a channel illumination device. Channel illumination devices are frequently used for signage including borders and lettering. In these devices, a wall structure outlines a desired shape to be illuminated, with one or more channels defined between the walls. A light source is mounted within the channel and a translucent diffusing lens is usually arranged at the edges of the walls so as to enclose the channel. In this manner, a desired shape can be illuminated in a desired color as defined by the color of the lens.

Typically, a gas-containing light source such as a neon light is custom-shaped to fit within the channel. Although the diffusing lens is placed over the light source, the light apparatus may still produce “hot spots,” which are portions of the sign that are brighter than other portions of the sign. Such hot spots result because the lighting apparatus shines directly at the lens, and the lens has limited light-diffusing capability. Incandescent lamps may also be used to illuminate such a channel illumination apparatus; however, the hot spot problem typically is even more pronounced with incandescent lights.

Both incandescent and gas-filled lights have relatively high manufacturing and operation costs. For instance, gas-filled lights typically require custom shaping and installation and therefore can be very expensive to manufacture. Additionally, both incandescent and gas-filled lights have high power requirements.

Channel illumination devices and other types of display lighting often are controlled by electronic circuitry connected to sensors that detect light levels throughout the day-night cycle and illuminate the channel light when appropriate during that cycle. One limitation of such sign/sensor configurations, however, is that the sensors must often be installed far from the sign itself so that light from the sign does not directly impinge on the sensor. Inconvenient remote installation is necessary to avoid falsely triggering the sensor. False triggering occurs when the sensor registers the appropriate low light level and triggers illumination of the lighting apparatus, but upon illumination the sensor registers the light from the apparatus and responds by dimming or extinguishing the illumination apparatus. As soon as the apparatus is turned off, the cycle begins again as the sensor registers a low light level and illuminates the apparatus, only to register the accompanying light as an indication that the apparatus should be turned off. As can be seen, such a vicious cycle of false triggering would impair the operability of the illumination apparatus.

The inventions disclosed herein solve this problem and present other advantages and improvements, some of which are described below.

### SUMMARY OF THE INVENTIONS

One embodiment of the disclosed inventions is a lighting apparatus having a body and a plurality of lamps on or adjacent the body. Each of the lamps is adapted to emit light having a wavelength within a first range of light wavelengths. The body also includes a sensor on or adjacent the body, and the sensor is adapted to sense light having a wavelength within a second range of light wavelengths. The lamps are controlled in accordance with conditions sensed by the sensor.

In another embodiment, the lighting apparatus is controlled so that power is supplied to the lamps when the sensor detects light below a predetermined intensity.

Another embodiment of the disclosed inventions is an illuminated display apparatus comprising one or a plurality of light emitting diodes (LEDs) that are adapted to emit light having a wavelength within a first range of wavelengths. This embodiment includes a light sensor adapted to detect light having a wavelength within a second range of light wavelengths that does not overlap the first range. The embodiment also includes a controller configured to receive inputs from the light sensor. The controller varies the intensity of the light emitted by the LEDs in accordance with inputs received from the light sensor.

In a further embodiment, the light sensor is configured to detect infrared radiation emitted by human body heat and the controller is configured to vary the intensity of light emitted by the LEDs according to the proximity of a body heat source.

These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a perspective view of a channel light with a sensor and LEDs.

FIG. 2 is a schematic representation of one embodiment of the disclosed inventions.

FIG. 3 is a schematic representation of one embodiment of a sensor module in accordance with the disclosed inventions.

FIG. 4 is a schematic representation of one embodiment of the disclosed inventions.

### DETAILED DESCRIPTION OF PREFERRED EMBODIMENTS

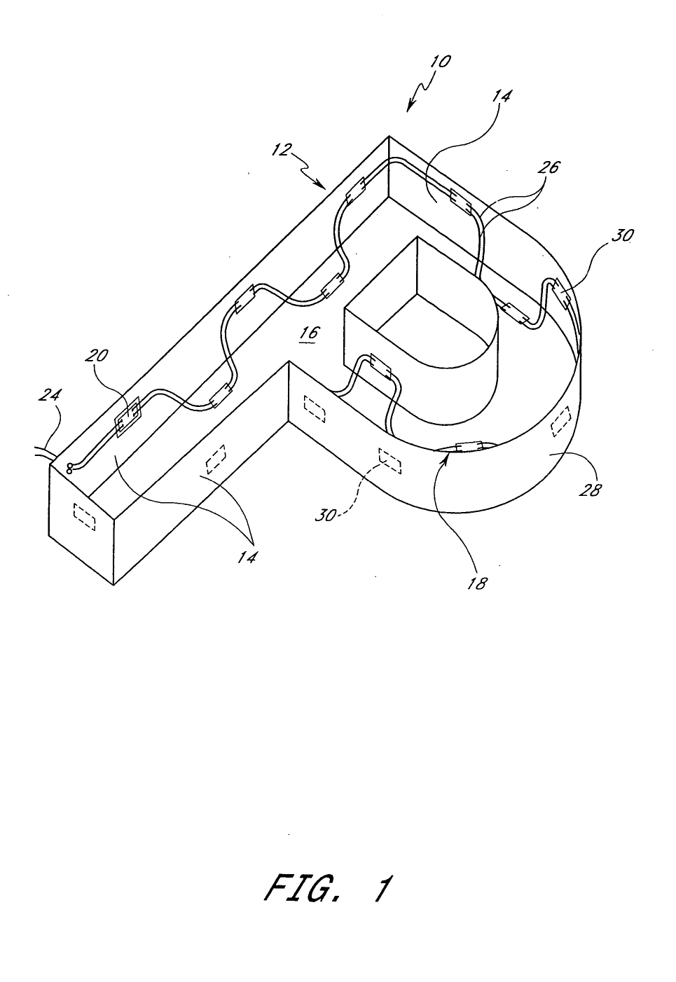

FIG. 1 illustrates an embodiment of a channel illumination apparatus 10 comprising a casing 12 in the shape of a letter “P.” The casing 12 includes a plurality of walls 14 and a back 16, which together define at least one channel. The illumination apparatus 10 further comprises power supply wires 24, a sensor module 20, light-emitting diode (LED) modules 30, and wires 26.

In the illustrated embodiment, the sensor module 20 is mounted to a wall 14 of the casing 12. The sensor module 20 is electrically connected, through wires 24, to a plurality of LED modules 30 that are attached to the walls 14 and the back 16 of the casing 12 in a spaced-apart manner. A translucent light-diffusing lens (not shown) is preferably disposed on a front edge 18 of the walls 14 and may completely or partially enclose the channel. Such an illumination apparatus 10 may be used for illuminated signage, and may sometimes be referred to as a sign or channel sign.

The walls 14 are optionally formed of a durable sturdy metal having relatively high heat conductivity. The surfaces of the walls 14 and back 16 of the casing 12 are advantageously diffusely reflective, preferably being coated with a flat white coating. In the embodiment illustrated by FIG. 1, the casing walls 14 are about 3 to 4 inches deep and the width of the channel is about 3 to 4 inches between the walls.

The illustrated LED modules 30 comprise one or multiple light-emitting diodes (LEDs) attached to a substrate that can in turn be attached to a surface such as a wall 14. The LEDs are electrically connected to one another and, when the appropriate electrical conditions are met, the diodes illuminate. When they illuminate, individual LEDs emit generally monochromatic light. That is, the wavelengths of the light rays generally emitted by an LED are within a limited and definable range.

The small size and low profile of the LED modules 30 enables the modules to be mounted at various places along the channel wall 14 or back 16. As illustrated in FIG. 1, some LED modules 30 are mounted on the walls 14, and some are mounted on the back 16. The modules are optionally spaced about 5 to 6 inches apart. In other embodiments, all of the LED modules 30 may be mounted on the walls 14 of an illumination apparatus 10, or all may be mounted on the back 16. The LED modules 30 may be mounted to the wall 14 with rivets or any other method of mounting. For example, LED modules 30 may be held in place with screws, glue, tape, magnetism, adhesive, etc.

As may be anticipated, larger channel apparatuses will likely require somewhat different arrangements of LED modules, including employing more LED modules. For example, a channel illumination apparatus having a channel width of 1 to 2 feet may employ LED modules on both walls, on the back, and may even use multiple rows of LED modules. Additionally, the orientation of each of the modules may be varied in such a large channel illumination apparatus. For instance, the LED modules may desirably be angled so as to direct light at various angles relative to the diffusely reflective surfaces.

For purposes of this specification, a lighting module includes a lamp that may be disposed within a channel or other illumination apparatus. Further, in this specification, the term “lamp” is a broad term that is used in its normal sense, and which includes an illumination source with or without a housing, casing or other packaging. An “LED module” is one type of lighting module and comprises at least one LED and associated circuitry mounted on a substrate. The substrate is then mounted to a body of an illumination apparatus. Additional examples of LED modules and details of how LED modules can be mounted are disclosed in U.S. Pat. No. 6,712,486, granted to Popovich et al. on Mar. 30, 2004, titled “MOUNTING ARRANGEMENT FOR LIGHT EMITTING DIODES,” the entirety of which is hereby incorporated by reference, and U.S. Pat. No. 6,578,986, granted to Swaris et al. on Jun. 17, 2003, titled “MODULAR MOUNTING ARRANGEMENT AND METHOD FOR LIGHT EMITTING DIODES,” the entirety of which is also hereby incorporated by reference.

Embodiments illustrated herein refer to lighting modules and LED modules that are formed separately from a body of an illumination apparatus. It is to be understood that such modules may be co-formed with the body. For example, in one embodiment, a module comprises a portion of a back of a channel apparatus having a dielectric formed thereon. Contacts are formed on the dielectric and LEDs are arranged on the contacts in an electrically-connected array. Several such modules may be formed on the back, and may be electrically connected to one another in a serial or parallel manner. It is to be understood, however, that the principles discussed herein may be employed with other configurations of illumination sources. For example, in other embodiments LEDs may be mounted directly on a body of an illumination apparatus in any desired arrangement, rather than being disposed in a modular arrangement.

In the illustrated embodiment, the sensor module 20 is affixed to the wall 14 of the casing 12 in a similar manner to the LED modules 30. The sensor module 20 is placed in close proximity to LED modules 30. In fact, the sensor module 20 is installed within the same channel as multiple LED modules 30. This proximate installation has many advantages, and it is does not result in false triggering of the sensor because the LEDs emit wavelengths of light to which the sensor does not respond, as explained further below.

In the illustrated embodiment, the sensor module 20 comprises an infrared photodiode configured to detect light having a wavelength in the range of approximately 700 to 900 nanometers (nm). Preferably, the sensor is adapted to detect light having a wavelength of about 800 nm. Preferably, the LED modules 30 emit light with wavelengths in the visible spectrum. For example, LED modules may emit blue (approximately 460 nm to approximately 500 nm), amber (approximately 530 nm to approximately 680 nm), red (approximately 600 nm to approximately 690 nm), or other colors of visible light. Because the LED modules 30 preferably emit light with wavelengths outside the 700-900 nm range, the infrared photodiode is blind to the LED light; this allows the sensor module 20 to function without being affected by whether or not the LED modules are emitting light. Indeed, when appropriately configured, the sensor module 20 can function in close proximity to LED modules 30 without erroneously triggering the illumination apparatus 10.

As explained above, LEDs emit generally monochromatic light. Preferably, the wavelengths of light detectable by the sensor are also within a limited range. The limited-wavelength sensor and the monochromatic LEDs complement each other when used according to the disclosed inventions, because the wavelengths of light detectable by the sensor are different from those wavelengths emitted by the LEDs. Preferably, the light to which the sensor is sensitive is not generated by the illumination apparatus 10. More preferably, the sensor is only sensitive to light from sources completely external to the illumination apparatus such as sunlight, for example. Preferably, the sensor module is further configured to appropriately distinguish between various light intensities to determine whether or not the sign should be illuminated. In accordance with this embodiment, the sensor module can be mounted inside a channel sign adjacent to lighting modules, thus streamlining installation and lowering cost. Furthermore, trouble-shooting can be accomplished in the factory or in-house, instead of at the sign installation site. For example, if the sensor module 20 is configured to only react to infrared radiation, the function of the sensor module 20 can be tested using an incandescent lamp.

With continued reference to FIG. 1, the LED modules 30 are preferably electrically connected in parallel relative to each other. Power supply wires 24 enter the channel casing 12 through a wall 14 or back 16 of the casing 12. The sensor module 20 is connected to the power supply wires 24 in series with the LED modules 30. That is, electrical current flows through the sensor module 20 before it flows to the LED modules 30. Preferably, the sensor module comprises a power control switch configured to electrical power from the wires 24 and to selectively supply the electrical power to the LED modules 30. Thus, in this configuration, the sensor module 20 effectively controls the flow of current to the LED modules 30 and controls when and if electrical power will be supplied to the LED modules 30. As understood by those of ordinary skill in the art, many alternative electrical configurations and connections may be employed to advantageously structure the electrical components and circuits described herein.

In the illustrated embodiment, the sensor module 20 controls the illumination apparatus 10. To accomplish this, the sensor module 20 comprises additional circuitry that receives input from the sensor, depending on the properties, quantity, or intensity of the light detected by the sensor. For example, the sensor module 20 may comprise a controller and a light sensor, where the controller is configured to receive and process input from the light sensor. The controller may simply turn the illumination apparatus 10 on or off, or the controller may be configured to vary the intensity of the light emitted by the LEDs in accordance with inputs received from the light sensor. Thus, the sensor module 20 can act as a simple binary switch or as an analog controller that dims and brightens the illumination apparatus 10. The sensor module 20 can accomplish this effect in many ways. For example, the sensor module can vary the voltage or the current in the circuit, or the sensor module can include a pulse width modulator (PWM) configured to vary a duty cycle of pulsing LEDs in order to control total light output of the LEDs. The illumination apparatus 10 can thus be automatically controlled by the sensor module 20, depending on the time of day or amount and characteristics of the light or radiation surrounding or impinging upon the illumination apparatus 10.

In some embodiments, the sensor module may communicate a signal to drivers corresponding to individual LED modules. The drivers can in turn activate or deactivate the LED modules, depending on the signal received.

In the illustrated embodiment, the illumination apparatus 10 comprises a sensor module 20 configured to allow power to be supplied to the LED modules 30 when the sensor detects light below a predetermined intensity. The predetermined intensity is calculated to correspond to twilight so that the sensor module 20 turns the LED modules 30 on at dusk and off at dawn. In this embodiment, when the sensor detects a light intensity below a trigger level of about 70 foot-candles (FC), the sensor module 20 allows electricity to illuminate the LED modules 30. It is to be understood that the trigger level can be set or adjusted to a different setting depending on the desired light trigger level. The sensor module 20 is configured to turn off power or halt a flow of electricity to the LED modules 30 when the sensor detects light above the predetermined intensity.

The predetermined intensity to which the sensor module 20 responds may correspond to a level of light anticipated at dusk or gloaming. One example of a predetermined intensity of light at approximately dusk is 100 FC of light. Another example of a possible predetermined intensity for illumination or deactivation is about 70 FC. Settings of a sensor module can be determined using the following approximate data: direct sunlight typically has a brightness of 10,000 FC; an overcast day typically has a brightness of approximately 1,000 FC; dusk typically has a brightness of approximately 70 FC; and a clear night typically has a brightness of approximately 0.001 FC.

One example of a sensor module that may be used in accordance with the disclosed inventions is a twilight photocell detector, model no. PL746-TPC, which is available from Permlight Products, Inc. An example of an LED module that may be used in accordance with the disclosed inventions is the Twiste'R™ model LED module, also available from Permlight Products, Inc. One example of a power cord that may be used in accordance with the disclosed inventions includes two 18 AWG conductors surrounded by an insulating sheet. Optionally, the power supply is a 12-volt alternating current or direct current power source.

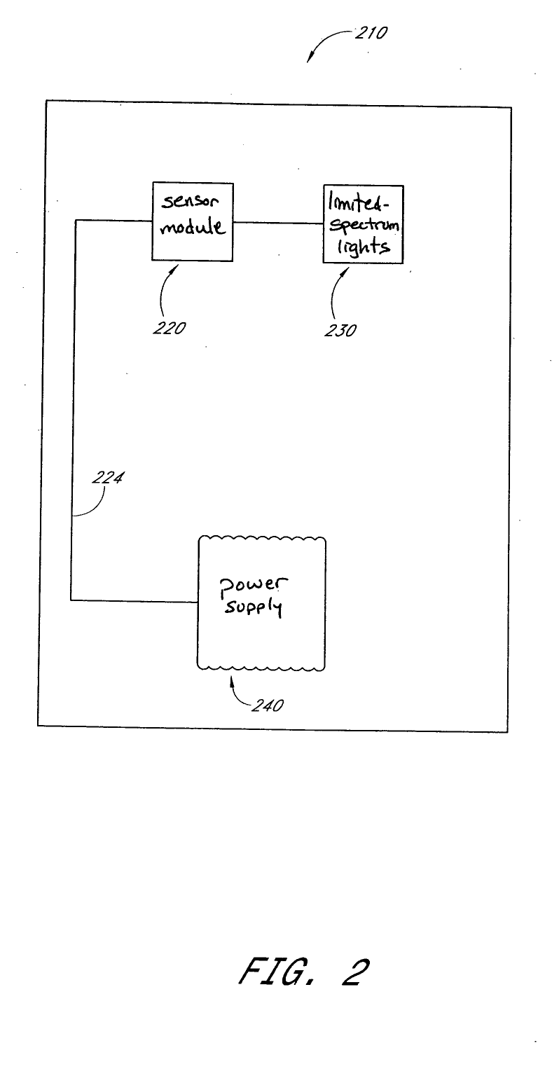

With reference to FIG. 2, an embodiment of a lighting system 210 is shown schematically. The lighting system comprises a sensor module 220, limited-spectrum lights 230, a power supply 240, and an electrical connection 224. The components of the lighting system 210 are connected by the electrical connection 224 to form one or multiple electrical circuits. Preferably, the sensor module 220 comprises a light sensor and a controller.

In one embodiment, the sensor module 220 is arranged electrically in series with the limited-spectrum lights 230. This provides the advantage of allowing the sensor module 220 to control the power supply to limited-spectrum lights 230 through a simple circuit-breaking switch. In another embodiment, the sensor module 220 may be electrically in parallel with some of the limited-spectrum lights 230, and electrically in series with others of the limited-spectrum lights 230. This advantageously allows selective control of portions of the lights 230.

In some embodiments, the lighting system 210 comprises a body to which the sensor module 220 and the limited-spectrum lights 230 are both physically attached such as, for example, the embodiment illustrated in FIG. 1. The limited-spectrum lights 230 can comprise one or a plurality of lamps, each of the lamps adapted to emit light having a wavelength within a first range of light wavelengths. The sensor module 220 comprises a sensor adapted to sense light having a wavelength within a second range of light wavelengths. Preferably, the first range of wavelengths and the second range of wavelengths do not overlap. That is, the wavelengths of light emitted by the limited-spectrum lights 230 are not detectable by sensor module 220. In some embodiments, the first and/or second range of wavelengths is not within the human-visible light spectrum. Preferably, the limited spectrum lamps 230 comprise LEDs that emit generally limited-spectrum light, such as monochromatic light, for example.

The sensor module 220 can control the limited-spectrum lights 230 in accordance with conditions sensed by the sensor module 220. In some embodiments, the sensor module 220 can be adapted to detect light that is not within the visible spectrum. Advantageously, the sensor module 220 comprises an infrared light sensor. Optionally, the sensor module 220 can be configured to detect light having a wavelength in the general range of approximately 700 to approximately 900 nanometers (nm). Optionally, an embodiment of the sensor module 220 can be adapted to detect light having a wavelength of about 800 nm.

In certain embodiments, the lighting system 210 can comprise limited-spectrum lights 230 that in turn comprise light emitting diodes (LEDs) having a generally monochromatic light output such as, for example, red, blue or amber monochromatic light. In some embodiments, the lighting system 210 can be configured so that the intensity of the limited-spectrum lights 230 is controlled in accordance with a sensed condition, detected by the sensor of the sensor module 220.

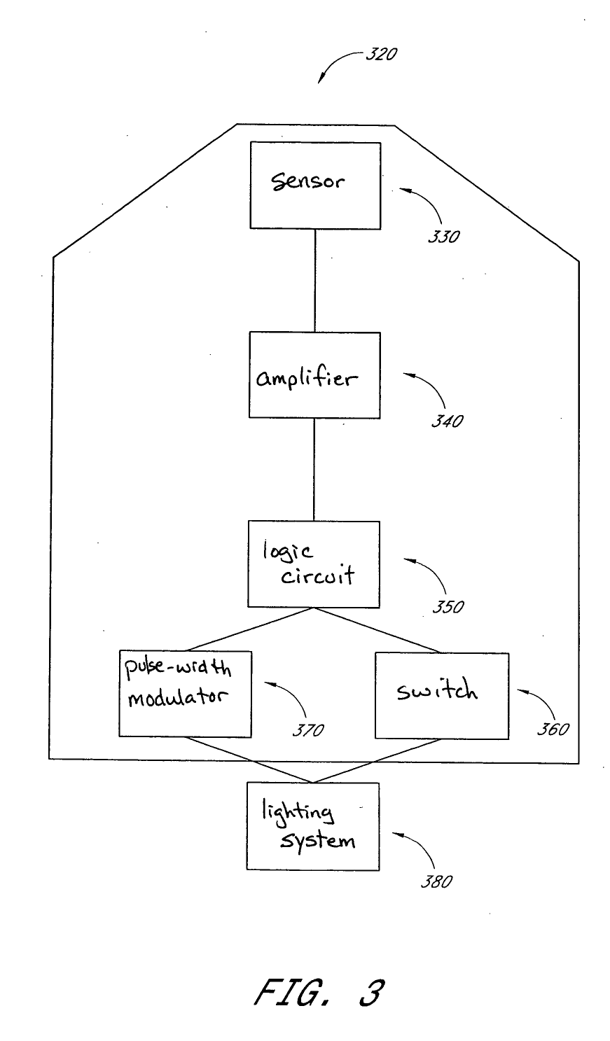

With next reference to FIG. 3, components of an embodiment of a sensor module 320 are shown schematically. The sensor module 320 comprises a sensor 330, an amplifier 340, a logic circuit 350, a pulse-width modulator (PWM) 370 and/or a switch 360. The sensor module 320 can also be in electrical communication with a lighting system 380.

In one embodiment, the sensor comprises an infrared sensor that is set to detect infrared light with wavelengths in the range of about 700-900 nm and more preferably about 800 nm. The sensor senses both the presence of detectable wavelengths of light and the intensity of that light.

The sensor 330 can comprise any of a number of various types of detectors. For example, the detector can comprise a pyrolytic detector, a thermopile, or gallium arsenide. The sensor 330 can also comprise a converter (not shown) that converts the sensor's response signal to a voltage when the relevant wavelength is detected.

With continued reference to FIG. 3, when the illustrated sensor detects light or radiation, it creates a signal. Preferably, the sensor signal is transmitted to the amplifier 340. The amplifier 340 amplifies the signal received from the sensor 330 to make the signal more powerful and easier for other components to detect. A logic circuit 350 receives the signal from the amplifier 340. The logic circuit can contain one or multiple sub-circuits designed to analyze the signal and coordinate and determine the appropriate response to the signal. The logic circuit 350 can contain, for example, a driver (not shown) that receives the signal from the amplifier 340 and determines whether or not predetermined signal levels have been met. The driver then calculates the appropriate response. For example, in one embodiment, as the voltage signal from the amplifier 340 varies, the logic circuit generates a signal to change the intensity of the lighting system 380 accordingly. Generally speaking, when certain conditions are met, the driver generates a signal to other components in order to control the lighting system 380.

In one embodiment, when the signal received by the controller indicates that the sensed light intensity is about 70 FC, the controller triggers the lighting system 380 to illuminate. The lighting system 380 remains illuminated so long as the sensed light intensity remains at or below about 70 FC. However, when the sensed light intensity rises above about 70 FC, the controller triggers the lighting systems 380 to terminate illumination. In another embodiment, the controller triggers illumination of the lighting system 380 upon receiving a signal indicating a light intensity at or below about 100 FC. It is to be understood that any desired triggering light intensity level can be set as the predetermined intensity level to which the sensor 330 will respond.

In one embodiment, the sensor module 320 comprises a binary switch 360 that turns a lighting system 380 on or off depending upon an input signal from the driver of the logic circuit 350. More specifically, the switch 360 controls whether power is supplied to the lighting system 280.

In another embodiment, the sensor module 320 comprises a driver configured to control the light intensity of the apparatus. More particularly, in one embodiment, the driver is configured to pulse the LEDs at a rate imperceptible to the human eye. For example, the LEDs are preferably driven at about 300 Hz or more. The intensity of light emitted by the LEDs is varied by controlling the duty cycle. Preferably the driver incorporates a duty cycle controller such as a pulse width modulator (PWM) 370.

In another embodiment, the sensor module 320 comprises a PWM 370 that adjusts the light output of the lighting system 380 according to the signal received from the logic circuit 350. The PWM 370 preferably varies light output by pulsing the LEDs and controlling the duty cycle of the pulsing. The duty cycle allows the lighting system 380 to be illuminated during a certain percentage of each cycle.

In particular, the duty cycle may be defined as the percentage of time the LED is illuminated during a given cycle or pulse. During a pulse cycle, an LED is first pulsed “on” to be illuminated and then turned “off” so that it is no longer illuminated. One cycle is defined as the period of time from when an LED is first turned “on” until immediately before it is turned “on” again. The cycle repeats quickly as the LED flashes on and off repeatedly. But the time that elapses after the LED turns off before it turns on again may vary. That is, the LED may be illuminated for any desired portion of the duty cycle. For example, the LED may be illuminated for 10%, 20%, 50%, 60%, 80%, and/or up to 100% of the cycle. Hence, for a given frequency, the duty cycle is measured as the percentage of the cycle time during which the LED is illuminated. Accordingly, a low duty cycle may be about 20% or lower, while a high duty cycle may be around 70% or higher. In applications in which a higher intensity light is desired, such as spot lighting or channel lighting, the control strategy involves driving the LEDs at a high duty cycle, such as about 80%, or higher, thus producing a more intense light than would be produced by a control strategy using a lower duty cycle.

The duty cycle may be controlled automatically according to predetermined parameters. Also, in other embodiments, various other structures and methods can be used for varying the light output of the LEDs. For example, a rheostat, potentiometer, variable resistor or the like can be used. In one embodiment, the driver comprises a manual DIP switch that is configured to selectively control the duty cycle of pulsed LEDs. In preferred embodiments, one or more sensors are configured to detect environmental parameters, and the driver is configured to evaluate sensor inputs and drive the LEDs according to a predetermined control strategy.

Although FIG. 3 illustrates embodiments of a sensor module 320 having distinct components, it is contemplated that any of the components can be combined with each other or placed in a different order within the sensor module 320. For example, the switch 360 may be incorporated into the logic circuit 350 or the PWM 370 can comprise a logic circuit 350. Furthermore, all of the illustrated components are not necessarily required. For example, the switch 360 may be employed without a need for a PWM 370. Alternatively, a PWM may be employed in place of and obviating the need for a switch 360. In certain embodiments, the PWM 370 and the switch 360 may be the very same component, where the PWM 370 has a binary setting that may accomplish the same purpose accomplished by a switch.

With reference again to FIG. 2, when the sensor module 220 is configured to respond to wavelengths that are different from those emitted by the limited-spectrum lights 230, the sensor may be advantageously arranged adjacent to limited-spectrum lights 230 so that light from the lights 230 impinges on the sensor of the sensor module 220 but does not falsely trigger the sensor of the sensor module 220.

Certain embodiments of the claimed inventions relate to methods of using and installing responsive lighting systems. In one embodiment, a lighting system having a body, such as, for example, the casing 12 of FIG. 1, is constructed. In this embodiment, a light source that gives off limited-spectrum light, or light of a certain range of wavelengths, is mounted to the body of the lighting system. A light sensor is then installed that detects light from a limited range of the spectrum. The wavelengths of light given off by the light source are preferably distinct from the wavelengths of light to which the sensor is sensitive. More specifically, the light source emits light having a wavelength within a first range of wavelengths, and the sensor senses light having a wavelength within a second range of wavelengths, and the first and second ranges do not overlap. The light sensor and light source can be advantageously installed within the same channel light. The light source and light sensor can be supplied with power from a power source.

In an embodiment wherein a sensor module is installed on the body of a lighting system adjacent to a limited spectrum lamp such that light from the limited spectrum lamp impinges thereon, the entire sign embodiment can be constructed as a unit. Preferably, the sensor module does not have to be mounted remotely from the lamp or lamps. In this embodiment, and in accordance with this method, the entire illumination apparatus can be constructed remotely, that is, far from the installation site. For example, the illumination apparatus can be constructed in a signmaker's shop.

Furthermore, with the sensor module and illumination lamps mounted adjacent one another, a sign maker can test the channel illumination apparatus at his or her facility without having to configure the illumination apparatus in any manner different than it will be configured when actually installed at a customer's premises. In this way, the channel illumination apparatus can be constructed, tested, and installed as a unitary or modular entity. Furthermore, with such an embodiment, installation is a simple, two-step process requiring only that the illumination apparatus be bolted in place and that electrical supply wires be connected.

Some embodiments of the claimed inventions relate to methods of operating a lighting apparatus. Sunlight or incandescent (broad-spectrum) light is allowed to impinge upon a sensor module. The sensor module turns the lights off in response to broad-spectrum light impinging upon the sensor. When the intensity of the sunlight or broad-spectrum light dims to a predetermined level, the sensor module detects the dimming light or absence of light and, in response, illuminates a lighting system or LEDs. Preferably, the sensor is configured to be blind to the wavelength of light emitted by the lighting system or LEDs.

The human eye detects only a small portion of the full range of radiation in the electromagnetic spectrum. There are many types of light that humans cannot see without the aid of man-made devices. Gamma rays, X-rays, ultraviolet light, infrared light, microwaves, and radio waves are all types of invisible light. Devices such as X-ray machines used by medical doctors to perform diagnoses and radar controllers that guide airplanes safely on their route are only a few examples of how invisible radiation plays an important role in our well being. The electromagnetic radiation spectrum is made up of radiation of many wavelengths, and several general groupings of wavelengths along the spectrum have been given names. At the end of the spectrum having the shortest wavelengths are gamma rays. In order of increasing wavelength, gamma rays are followed by X-rays, ultraviolet (UV) light, visible light, infrared radiation, microwaves, and radio waves. Wavelength can be defined as the distance between two peaks of a wave. The wavelengths of electromagnetic radiation is commonly measured in nanometers (1×10⁻⁹ meters). The shorter the wavelength of radiation, the higher the energy of that radiation. But longer wavelength radiation also has useful properties.

Infrared radiation lies in the range above 700 nm between visible light and microwave radiation. Infrared radiation can also comprise thermal radiation, or heat. This radiation is produced by any object that has a temperature above absolute zero. Although infrared radiation is invisible to humans, we encounter this type of emission every day in the form of heat from sunlight, ovens, incandescent bulbs, and even ice cubes. An important characteristic of infrared radiation is its longer wavelength that enables it to travel through most objects such as clouds, dust and plex material used in signs. It also has a low refractive rate which allows almost all infrared rays to permeate many materials.

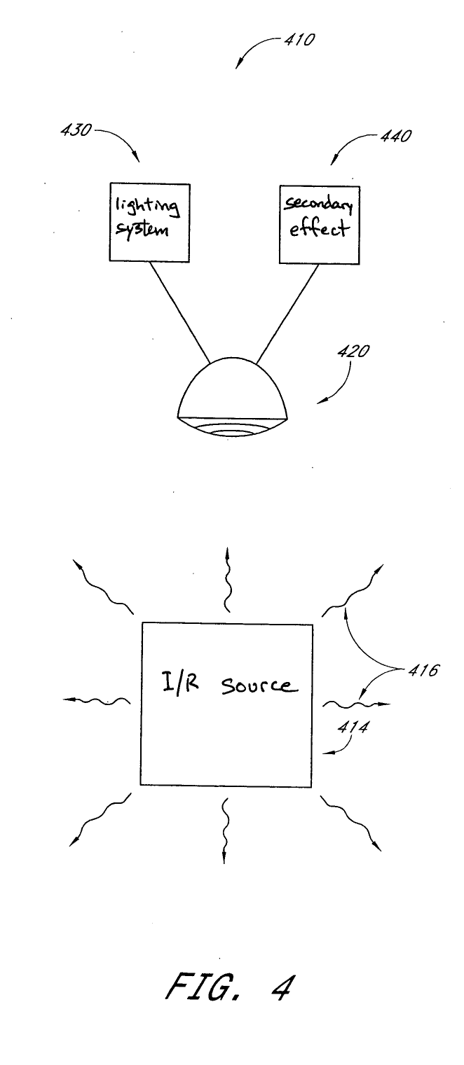

With reference to FIG. 4, an embodiment of a responsive lighting system 410 is schematically illustrated. The responsive lighting system 410 comprises a sensor module 420, a lighting system 430, and a secondary effect 440, and is responsive to an infrared source 414 that generates infrared radiation 416. FIG. 4 schematically illustrates infrared radiation 416 emanating from the infrared radiation source 414 and impinging on the sensor module 420.

In one embodiment, the responsive lighting system 410 comprises a sensor module 420 having a sensor that is configured to sense radiated human body heat. Body heat is infrared radiation having a wavelength within a range of about 6,000 to about 8,000 nm. Thus, the sensor is preferably configured to sense infrared radiation at wavelengths in a range from about 6,000 to about 8,000 nm. Preferably, the sensor is further configured to sense an intensity of body heat that varies with proximity of the body heat source to the sensor. More specifically, the sensor reaction preferably intensifies with the intensity of the detected heat. Increasing heat intensity often indicates that the heat source is moving closer to the sensor.

With continued reference to FIG. 4, a preferred embodiment of a responsive lighting system detects if an infrared heat source, specifically a human body, is approaching or moving away from the sensor; the system further detects how close the source is to the sensor. The sensor module then controls the illumination apparatus accordingly. More specifically, as the infrared heat source approaches the sensor, the sensor module causes the illumination lamps to vary in intensity, becoming brighter or dimmer.

In one embodiment, the infrared source 414 is a shopper inside a store or on the street near a display window of a commercial establishment. The sensor module 420 is integrated with or adjacent to a product display either in a store window or inside the store itself near where the consumer would approach. As the consumer approaches, the sensor module detects the increasing intensity of infrared radiation 416 emanating from the consumer and triggers a lighting system 430 that calls the consumer's attention to the product or group of products. For example, the sensor module 420 can control the lighting system 430 to move through a series of different intensities or through a series of different colors as the consumer approaches. Optionally, the sensor module 420 can dim the lights generally around the product display as the consumer approaches, only to illuminate them more brightly upon the consumer's arrival near the display at a predetermined location or distance from the sensor. Alternatively, the sensor module 420 can dim the lights around the product display except for one area of the display in which a certain product is highlighted using a spotlight, LED or other lighting mechanism. Preferably, the lighting system 430 is a limited-spectrum lighting system incorporating, for example, LEDs. Preferably, the lighting system 430 emits radiation at wavelengths to which the sensor module 420 is blind, thus eliminating interference between the lighting system 430 and the operation of the sensor module 420.

In one embodiment, a responsive lighting system 410 is hard-wired to an electric power supply system. In another embodiment, the responsive lighting system 410 may be removably connected (for example, “plugged in”) to a typical 120 volt electrical supply system and includes a power converter to transform the supplied electricity to a desired form, usable by the sensor module 420 and lighting system 430. In still another embodiment, the responsive lighting system 410 comprises a battery that supplies power for the system. Further, in a preferred embodiment, the responsive lighting system 410 may be selectively moved and secured in place with fasteners, clips, magnets, or the like.

In some embodiments, the sensor module 420 is configured to actuate a secondary effect 440 when the sensed body heat intensity exceeds a threshold value. In some embodiments, the sensor module 420 can trigger secondary or tertiary effects such as sound effects or movements of physical objects in relation to the product display described above.

In one embodiment, the infrared radiation source 414 comprises a visitor or intruder approaching a porch or other selected area of a building. As the intruder or guest approaches the porch, the approaching person emits infrared radiation 416. The infrared radiation 416 is detected by the sensor module 420 that is installed on or near the porch or doorway. In a dynamic response process, sensor module 420 can control a lighting system 430 and adjust the intensity or color of lights in the lighting system 430 in relation to the distance of the intruder or guest from the sensor module 420. Preferably, the lamps of the lighting system do not emit wavelengths of light that would be detected by the sensor. In one embodiment, the sensor module 420 comprises a pulse width modulator (PWM) and the lighting apparatus 430 comprises LEDs. When the intruder or guest is approximately 15 or more feet away, the PWM controls the duty cycle to allow no or low light output from the lighting system 430 (for example, a 0%-10% duty cycle). However, as the intruder or guest approaches, the PWM increases the duty cycle, increasing the intensity of the light emitted by the lighting apparatus 430. Concurrently, the infrared radiation emanating from the approaching person becomes more distinguishable from the background infrared radiation. When the person is very close to the sensor module 420, the lighting system is very bright. For example, when the person is close, the duty cycle could result in a 90% or 100% light output from the lighting system 430.

In another embodiment, the sensor module communicates with and controls a secondary effect 440 such as a second lighting system. The second lighting system can be an incandescent lighting system with a higher light intensity potential than an LED lighting system. The first lighting system 430 can be configured to illuminate according to the approach of the person, and the secondary lighting system can be configured to illuminate only when the person is very close to the sensor module 420. This arrangement conserves energy because of the low energy requirements of an LED lighting system 430 compared to the relatively high energy requirements of a more traditional incandescent lighting system. This configuration allows for an incandescent lighting system to be used when appropriate, such as when a brighter, broader-spectrum light is desired. In this embodiment, the broad-spectrum incandescent lighting system is controlled with a timer, motion sensor or other sensor so that it will turn itself off as appropriate. Without such an independent control, the infrared light emitted by such a broad-spectrum incandescent light would continuously trigger the sensor module 420, maintaining the illuminated state unnecessarily. In another embodiment, the sensor is shielded from the incandescent lamp so as not to be triggered by the lamp. In other embodiments, the secondary effect 440 can comprise an audio circuit comprising an alarm, warning, or other kind of sound.

As described above, in some embodiments, the sensor module 420 is configured to vary the intensity of light emitted by LEDs as the heat source approaches the sensor. For example, in the embodiment described above, the sensor module 420 is configured to increase the light intensity as the body heat source approaches the sensor. In some embodiments, however, the sensor module 420 is configured to decrease the light intensity as the heat source approaches the sensor.

One example of an embodiment wherein the sensor module 420 is configured to decrease the light intensity as the heat source approaches relates to a patient in a hospital. In this embodiment, the infrared source 414 comprises a person in a hospital room. The person emits infrared radiation 416 that is sensed by a sensor module 420. As the person approaches the sensor, which is installed near a hospital bed (not shown), the sensor 420 detects a change in the intensity or direction or amount of infrared radiation 416 and controls a lighting system 430, causing the lighting system 430 to become dimmer. As the patient approaches the bed, the lights dim to a greater extent until finally the sensor module turns off the lights completely. The turning off or maximum dimming of the light can be timed to coincide with the person arriving at the hospital bed. In this way, the responsive lighting system 410 can automatically and dynamically control the lights in a hospital room according to the varying need for those lights. Such a lighting system could be further configured to illuminate lights or activate an effect when the person arises in the morning, either to sit up in bed or to move away from bed. Such a configuration may be desirable for a person who must visit the bathroom or any other room during the darkest hours of the night or morning, for example. Such an effect may further be desirable if the light or effect were not perceptible to the hospital patient herself, but were only perceptible to alert a nursing staff that a hospital patient was getting out of bed, for example.

In one embodiment, the sensor module 420 is configured to detect overheating by an incandescent or fluorescent lighting system such as a street lamp and turn off the overheating street lamp while concurrently triggering an LED lighting system.

In one embodiment, the responsive lighting system 410 is employed to scare animals, birds or pests away from crops or other advantageously pest-free places. For example, a thermal sensor module combined with lighting or other effects is employed to detect a fox or other animal approaching a chicken coop or other location warranting protection and may respond to the stealthy approach of the predator with a dynamic series of startling light or sound responses. A similarly-configured embodiment could alternatively be employed to keep birds out of a field.

As suggested by the numerous and varied exemplary embodiments described above, a responsive lighting system 410 can comprise many different embodiments. Indeed, each of the components of a responsive lighting system 410 can have many advantageous embodiments, taken in various combinations. The infrared radiation source 414, for example, can comprise any object or entity that emits infrared radiation, including a human being, an animal, a vehicle, etc. Furthermore, the sensor module 420 can comprise the various components schematically illustrated in FIG. 3. In accordance with an embodiment illustrated in FIG. 4, the sensor module 420 may be sensitive at least to certain wavelengths of infrared radiation. The sensor module 420 communicates with and controls a lighting system 430 and one or a plurality of other effects such as the secondary effect 440 schematically illustrated in FIG. 4. There are many possible secondary effects, including a second lighting system having one or multiple LEDs or incandescent lights, a sound system having one or more speakers, a sound effect, an alarm, a light or sound greeting, a physical movement of an object, a message, a change in light color or intensity, etc.

Although this invention has been disclosed in the context of certain preferred embodiments and examples, it will be understood by those skilled in the art that the present invention extends beyond the specifically-disclosed embodiments to other alternative embodiments and/or uses of the invention and obvious modifications and equivalents thereof. In addition, while a number of variations of the invention have been shown and described in varying levels of detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

1. A lighting apparatus, comprising
a body;
a plurality of lamps on or adjacent the body, each of the lamps adapted to emit light having a wavelength within a first range of light wavelengths and not emit light having a wavelength outside the first range; and
a sensor on or adjacent the body, the sensor adapted to sense light having a wavelength within a second range of light wavelengths and not sense light having a wavelength outside the second range;
wherein the lamps are controlled in accordance with conditions sensed by the sensor.

2. The lighting apparatus of claim 1, wherein the first and second ranges do not overlap.

3. The lighting apparatus of claim 2, wherein the lamps comprise light emitting diodes.

4. The lighting apparatus of claim 1, wherein the apparatus is configured so that the intensity of light emitted by the lamps is controlled in accordance with the sensed condition.

5. The lighting apparatus of claim 2, comprising a controller, and the controller allows power to be supplied to the lamps when the sensor detects light below a predetermined intensity.

6. The lighting apparatus of claim 5, wherein the predetermined intensity corresponds to a level of light anticipated at dusk.

7. The lighting apparatus of claim 5, wherein the predetermined intensity is less than about 100 foot-candles.

8. The lighting apparatus of claim 7, wherein the predetermined intensity is less than about 70 foot-candles.

9. The lighting apparatus of claim 1, wherein the sensor is arranged so that light from the lamps impinges on the sensor.

10. The lighting apparatus of claim 2, wherein the sensor is adapted to detect light that is not within the visible spectrum.

11. The lighting apparatus of claim 10, wherein the sensor comprises an infrared photo diode.

12. The lighting apparatus of claim 11, wherein the second range is from about 700-900 nm.

13. The lighting apparatus of claim 12, wherein the sensor is adapted to detect light having a wavelength about 800 nm.

14. An illuminated display apparatus, comprising:
a plurality of light emitting diodes (LEDs) adapted to emit only light having a wavelength within a first range of light wavelengths;
a radiation sensor adapted to detect only light radiation having a wavelength within a second range of light wavelengths that does not overlap the first range; and
a controller configured to receive inputs from the light sensor;
wherein the controller varies the intensity of light emitted by the LEDs in accordance with inputs received from the light sensor.

15. The illuminated display apparatus of claim 14, wherein the second range of wavelengths is not within the visible spectrum.

16. The illuminated display apparatus of claim 14, wherein the sensor comprises an infrared light sensor.

17. The illuminated display apparatus of claim 16, wherein the sensor is configured to sense radiation emitted by human body heat.

18. The illuminated display apparatus of claim 17, wherein the sensor is configured to sense radiation within a range of wavelengths of about 6,000 to 8,000 nm.

19. The illuminated display apparatus of claim 17, wherein the sensor is configured to sense an intensity of body heat that varies with proximity of the body heat source to the sensor.

20. The illuminated display apparatus of claim 19, wherein the controller is configured to vary the intensity of light emitted by the LEDs as the body heat source approaches the sensor.

21. The illuminated display apparatus of claim 20, wherein the controller is configured to increase the light intensity as the body heat source approaches the sensor.

22. The illuminated display apparatus of claim 20, wherein the controller is configured to decrease the light intensity as the body heat source approaches the sensor.

23. The illuminated display apparatus of claim 19, wherein the controller is configured to actuate a secondary effect when the sensed body heat intensity exceeds a threshold value.

24. The illuminated display apparatus of claim 23, wherein the secondary effect is a non-lighting effect.

25. The illuminated display apparatus of claim 24, wherein the secondary effect is an auditory effect.

26. The illuminated display apparatus of claim 24, wherein the secondary effect is a lighting effect.

27. The illuminated display apparatus of claim 20, wherein the display apparatus comprises a battery configured to power the LED, sensor, and controller.
